(19) United States
(12) Patent Application Publication
(10) Pub. No.: US 2021/0268584 A1
(43) Pub. Date: Sep. 2, 2021

(54) FUSED FILAMENT FABRICATION OF BALLISTIC ARTICLES

(71) Applicants: Rolls-Royce Corporation, Indianapolis, IN (US); Rolls-Royce North American Technologies, Inc., Indianapolis, IN (US)

(72) Inventors: Quinlan Yee Shuck, Indianapolis, IN (US); Scott Nelson, Carmel, IN (US); Raymond Ruiwen Xu, Carmel, IN (US); Brandon David Ribic, Noblesville, IN (US); Matthew R. Gold, Carmel, IN (US)

(21) Appl. No.: 17/097,746

(22) Filed: Nov. 13, 2020

Related U.S. Application Data
(60) Provisional application No. 62/935,518, filed on Nov. 14, 2019.

(51) Int. Cl. B22F 10/18; B29C 64/165; B29C 64/118; B22F 3/10; B33Y 10/00; B33Y 30/00; B33Y 80/00; B33Y 70/10; F41H 5/02

(52) U.S. Cl. CPC B22F 10/18; B29C 64/165; B29C 64/118; B22F 3/1021; B29L 2031/768; B33Y 30/00; B33Y 80/00; B33Y 70/10; F41H 5/02; B33Y 10/00

(57) ABSTRACT

In some examples, a method for forming a ballistic armor article, the method including forming a preform article by depositing a filament via a filament delivery device, wherein the filament includes a sacrificial binder and a powder; removing the binder from the preform article; and sintering the preform article to form the ballistic armor article, wherein the ballistic armor article is configured to absorb energy from an external projectile that impacts the ballistic armor article, and wherein the ballistic armor article is configured to prevent the projectile from penetrating through the ballistic armor article.

This application claims the benefit of U.S. Provisional Patent Application No. 62/935,518, titled, “FUSED FILAMENT FABRICATION OF BALLISTIC ARTICLES”, filed Nov. 14, 2019, which is incorporated herein by reference in its entirety.

### TECHNICAL FIELD

The disclosure relates to additive manufacturing techniques, in particular, to additive manufacturing of components such as ballistic armor articles.

### BACKGROUND

Additive manufacturing generates three-dimensional structures through addition of material layer-by-layer or volume-by-volume to form the structure, rather than removing material from an existing volume to generate the three-dimensional structure. Additive manufacturing may be advantageous in many situations, such as rapid prototyping, forming components with complex three-dimensional structures, or the like. In some examples, additive manufacturing may include fused deposition modeling or fused filament fabrication, in which heated material, such as polymer, is extruded from a nozzle and cools to be added to the structure.

### SUMMARY

The disclosure describes example techniques, systems, materials, and compositions for additively manufacturing of ballistic armor articles using fused filament fabrication.

In some examples, the disclosure describes a method for forming a ballistic armor article, the method comprising forming a preform article by depositing a filament via a filament delivery device, wherein the filament includes a sacrificial binder and a powder; removing substantially all the binder from the preform article to form a powder article; and sintering the powder article to form the ballistic armor article, wherein the ballistic armor article is configured to absorb energy from an external projectile that impacts the ballistic armor article with a kinetic energy below a threshold amount, and wherein the ballistic armor article is configured to prevent the projectile with the kinetic energy below the threshold amount from penetrating through the ballistic armor article.

In some examples, the disclosure describes an additively manufactured ballistic armor article formed from a filament including a powder and a binder, wherein the ballistic armor article is configured to absorb energy from an external projectile that impacts the ballistic armor article with a kinetic energy below a threshold amount, and wherein the ballistic armor article is configured to prevent the projectile with the kinetic energy below the threshold amount from penetrating through the ballistic armor article.

In some examples, the disclosure describes additive manufacturing system comprising a substrate defining a major surface; a filament delivery device; and a computing device configured to control the filament delivery device to form a preform article, wherein the filament includes a sacrificial binder and a powder; wherein substantially all the binder is configured to be removed from the preform article, and the article sintered to form a ballistic armor article, wherein the ballistic armor article is configured to absorb energy from an external projectile that impacts the ballistic armor article with a kinetic energy below a threshold amount, and wherein the ballistic armor article is configured to prevent the projectile with the kinetic energy below the threshold amount from penetrating through the ballistic armor article.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual block diagram illustrating an example system for forming an additively manufactured component by fused filament fabrication of a material including a metal or alloy powder and a binder.

FIGS. 2-4 are schematic diagrams illustrating an example ballistic armor article in accordance with an example of the disclosure.

FIG. 5 is a flow diagram illustrating an example technique for forming an additively manufactured component using fused filament fabrication.

FIG. 6 is a conceptual diagram illustrating an example cross-section of an article formed by a FFF process prior to sintering of the powder.

### DETAILED DESCRIPTION

The disclosure generally describes techniques for forming additively manufactured components such as ballistic armor articles using fused filament fabrication (FFF). Additive manufacturing of metal or alloy components may present unique challenges, for example, compared to additive manufacturing of polymeric components. For example, while techniques such as powder bed fusion (including direct metal laser sintering, electron beam melting, selective laser sintering, or the like) which use a directed energy beam to fuse and sinter material may be useful in additive manufacturing, some alloys may respond to energy beams in a manner that may not be conducive to localized melting or localized sintering. Further, powder bed fusion may leave residual unfused or unsintered powder residue, for example, within channels or hollow internal passages of an additively manufactured component. Powder bed fusion of high temperature alloys may also result in components that may be prone to cracking due to localized melting and thermal gradients.

In some examples, a material including a sacrificial binder and a powder including metal, alloy, and/or other material dispersed in the binder may be deposited using fused filament fabrication to form an additively manufactured component. After additively forming one or more layers of the component, or after forming the entire component, the binder may be selectively removed or sacrificed from the layers or the component, for example, using heating, chemical dissolution, or the like. Sacrificing the binder from the layers or the component may leave substantially only the powder in the layers or the component. The component may be further treated, for example, by sintering, to strengthen or densify the powder and form the additively manufactured component. By using the material including the sacrificial binder and the powder, removing the sacrificial binder, and sintering the powder, high-melt temperature alloys may be used, residual (free) powder may be reduced, and crack propensity may be reduced due to the absence of melting. Further, microstructure of the additively manufactured component may be more carefully controlled by controlling microstructure of the powder and avoiding melting of the powder during processing.

In some examples, the disclosure relates to ballistic armor articles formed by a FFF process. Examples include a ballistic armor article that functions as a barrier to projectiles by absorbing the kinetic energy of the projectile when the projectile impacts the article. In some examples, the ballistic article may absorb the kinetic energy of the projectile such that the projectile is prevented from penetrating through the barrier and/or interacting with a component inside the barrier in a manner that damages the underlying component. In some examples, the ballistic armor article may act as a protective covering that prevents damage to an underlying object, e.g., from a ballistic impact. A ballistic impact may refer to an impact from a relatively small mass object (projectile) having a high velocity.

Example objects protected by the ballistic armor article may include all or a portion of a human body or vehicles, such as, aircraft, a wheeled vehicle, tracked vehicle, a space vehicle, a space probe, or the like. In some examples, the ballistic armor article protects all or a portion of engine of a vehicle, such as an aircraft, from damage caused by a projectile impact by forming a barrier between the projectile and engine. The ballistic articles may protect such objects from impacts with other objects moving at relatively high velocity, such as, bullets and/or shrapnel (e.g., from an explosion). In some examples, the ballistic articles may be employed to protect systems and components in space and/or those that operate in low or microgravity environments. Those systems and components may include artificial satellites, including telescopes or other man-made systems or satellites that operate in orbit of a planet. Example ballistic articles of the disclosure may be employed to protect such objects from impacts from projectiles, including ballistic and non-ballistic impacts from, e.g., relatively small objects as compared to the size of the ballistic article.

In some examples, the ballistic articles may include one or more layers formed by a FFF process. Using the FFF process, the ballistic articles, e.g., for ballistic or armor applications, may exhibit geometric and/or chemical composition properties that modify projectile fragmentation or kinetic energy absorption/transmission for ballistic or armor applications. For example, by tailoring the geometry, composition, or other properties of the ballistic armor article using the FFF process, preferential failure sites may be defined in the ballistic armor article. Upon impact of the ballistic armor article with a projectile, the ballistic armor article may fracture and/or fragment into small pieces to absorb the kinetic energy of the projectile, e.g., in the area of the preferential failure site.

As described above, the fused filament fabrication process may constitute an additive manufacturing process that does not include melting of materials. As such, a FFF process may offers unique advantages for the production of articles for ballistic armor applications, e.g., those articles which are not readily produced by fusion additive manufacturing methods (laser or electron beam) due to potential for cracking, lack of fusion (e.g., of one or more described material compositions), distortion, or poor mechanical properties. Ballistic articles that may be produced using a FFF process may include metals, alloys, ceramics, and/or polymer materials. As one example, a metal or alloy (e.g., steel alloy) having a relatively high hardness and/or fracture toughness may be used as a material for the ballistic armor despite the material having a low weldability and/or fusibility.

In some examples, the FFF process may include the production of single or multi-material ballistic armor articles having geometries or other properties which promote or modify kinetic energy absorption and/or transmission, enhance article fragmentation, and/or incoming projectile fragmentation. Examples may include layered structures or geometries which act as intentional fragmentation initiation sites within the article (e.g., thin sections or radii to promote localized fracture and fragmentation). The same or substantially similar results may be obtained via introduction of multiple materials and/or localized regions within the ballistic armor article. Relevant mechanical properties of localized regions within the article that may be modified via material selection based upon the constituent's fracture toughness, hardness, density, elastic modulus, and/or yield strength.

In some examples, the ballistic armor article may have a density gradient, e.g., with the article having a relatively low density in a portion of the ballistic armor article at or near the projectile impact surface with another portion having higher density further away from the impact surface. In such a configuration, the lower density portion of the armor article may define a preferential failure site within the ballistic armor article that fractures and/or fragment upon impact from a projectile to absorb kinetic energy from the projectile. The kinetic energy may be transferred within the portion of the armor article having the lower density to reduce the overall amount of energy transferred to the higher density portion of the armor article. The article may include similar gradients for one or more other properties described herein, e.g., fracture toughness, hardness, elastic modulus, and/or yield strength. Such gradients may be readily achieved using a FFF process to form the ballistic armor article.

In some examples, the ballistic armor article may include one or more layers or regions within the armor article that fracture in response to a ballistic impact or other impact from a projectile moving at a relatively high velocity. The impact and fracture of the material of the one or more layers may absorb at least a portion of the kinetic energy of the projectile. In some examples, the one or more layers configured to fracture upon impact from the projectile may be formed of relatively hard material(s). The hard material may deflect and/or fragment the projectile upon impact.

In some examples, the one or more layers may be formed by the FFF process tailored to have a predefined fracture and/or fragmentation sites within the one or more layers. For example, by using tailored compositions (e.g., two or more materials within a layer having different properties) and/or geometries (e.g., areas of differing cross-sectional thickness for an individual layer) within the one or more layers, the fracture and fragmentation of the one or more materials resulting from the impact of the projectile may be controlled (e.g., to transfer the energy over a larger area of the armor article rather than absorbing the energy of the projectile within a localized area) as desired within the ballistic armor article.

Additionally, or alternatively, the ballistic armor article may include one or more layers configured to prevent penetration of the projectile and/or fragments of the armor article. Rather than fracturing in response to the ballistic impact, the material properties of the layer allow the layer to absorb the energy of the projectile, projectile fragments and/or fragments of other overlying material of the armor article.

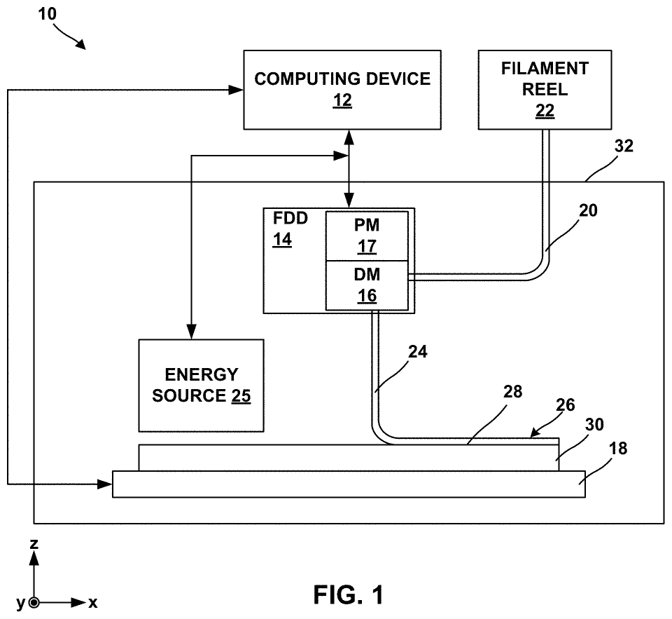

FIG. 1 is a conceptual block diagram illustrating an example fused filament fabrication system 10 for performing fused filament fabrication to form an additively manufactured component including a powder and a binder by filament delivery. Additive manufacturing system 10 may include computing device 12, filament delivery device 14, enclosure 32, and stage 18. System 10 is one example of a FFF system that may be used to form one or more of the example ballistic armor articles described herein. The FFF process may allow for properties of the armor article to be tailored, e.g., by forming gradients in the thickness direction and/or other direction of the armor article). The tailored material properties may include material composition, density, hardness, fracture toughness, elastic modulus, and/or yield strength. The FFF process may also allow ballistic armor articles to have unique geometrical properties. In some examples, the tailored properties may function to define preferential failure sites within the ballistic armor article, e.g., to preferentially distribute the energy absorbed from the kinetic energy of the projectile during impact.

Computing device 12 may include, for example, a desktop computer, a laptop computer, a workstation, a server, a mainframe, a cloud computing system, or the like. Computing device 12 is configured to control operation of additive manufacturing system 10, including, for example, filament delivery device 14, stage 18, or both. Computing device 12 may be communicatively coupled to filament delivery device 14, stage 18, or both using respective communication connections. In some examples, the communication connections may include network links, such as Ethernet, ATM, or other network connections. Such connections may be wireless and/or wired connections. In other examples, the communication connections may include other types of device connections, such as USB, IEEE 1394, or the like. In some examples, computing device 12 may include control circuitry, such as one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Filament delivery device (FDD) 14 may include, for example, a delivery mechanism (DM) 16 for delivering a filament 20 to or near stage 18, and an optional positioning mechanism (PM) 18. Filament delivery device 14 may advance filament 20 from a filament reel 22 and heat filament 20 to above a softening or melting point of a component of filament 20 (e.g., a polymeric binder) to form a softened filament 24. Softened filament 24 is then extruded from delivery mechanism 16 and laid down in a road 26 on a major surface 28 of a substrate 30 (or, in subsequent layers, on a previously deposited road). The softened filament 34 cools and, in this way, is joined to other roads.

Substrate 30 may include a build plate on stage 18, or any suitable substrate defining a build surface. For example, substrate 30 may include a metal or glass plate defining a substantially planar surface. In other examples, substrate 30 may include surface features or a shaped (e.g., curved or curvilinear) surface on which the additively manufactured component is manufactured. In some examples, system 10 may not include a separate substrate 30, and filament delivery device 14 may deposit softened filament 24 on a build surface defined by stage 18, or on another component, or on layers of prior softened filament 24 or another material.

In some examples, filament delivery device 14 may, instead of receiving filament 20 from filament reel 22, include a chamber that holds a volume of a composition. The composition may be flowable, extrudable, or drawable from filament delivery device 14, for example, from delivery mechanism 16, in the form of softened filament 24 that may be deposited on or adjacent stage 18 or substrate 30. Softened filament 24 of the composition may be dried, cured, or otherwise solidified to ultimately form an additively manufactured component. In some examples, system 10 may include an energy source 25 configured to deliver energy to softened filament 24 to cure softened filament 24, for example, by photocuring or thermally curing the composition of softened filament 24.

Computing device 12 may be configured to control relative movement of filament delivery device 14 and/or stage 18 to control where filament delivery device 14 delivers softened filament 24. For example, stage 18 may be movable relative to filament delivery device 14, filament delivery device 14 may be movable relative to stage 18, or both. In some implementations, stage 18 may be translatable and/or rotatable along at least one axis to position substrate 30 relative to filament delivery device 14. For instance, stage 18 may be translatable along the z-axis shown in FIG. 1 relative to filament delivery device 14. Stage 18 may be configured to selectively position and restrain substrate 30 in place relative to stage 18 during manufacturing of the additively manufactured component.

Similarly, filament delivery device 14 may be translatable and/or rotatable along at least one axis to position filament delivery device 14 relative to stage 18. For example, filament delivery device 14 may be translatable in the x-y plane shown in FIG. 1, and/or may be rotatable in one or more rotational directions. Filament delivery device 14 may be translated using any suitable type of positioning mechanism 17, including, for example, linear motors, stepper motors, or the like.

Computing device 12 may be configured control movement and positioning of filament delivery device 14 relative to stage 18, and vice versa, to control the locations at which roads 26 are formed. Computing device 12 may be configured to control movement of filament delivery device 14, stage 18, or both, based on a computer aided manufacturing or computer aided design (CAM/CAD) file. For example, computing device 12 may be configured to control filament delivery device 14 (e.g., positioning mechanism 17) to trace a pattern or shape to form a layer including a plurality of roads on surface 38. Computing device 12 may be configured to control filament delivery device 14 or stage 18 to move substrate 30 away from filament delivery device 14, then control filament delivery device 14 to trace a second pattern or shape to form a second layer including a plurality of roads 26 on the first layer. Computing device 12 may be configured to control stage 18 and filament delivery device 14 in this manner to result in a plurality of layers, each layer including a traced shape or design. Together, the plurality of layers defines an additively manufactured component.

System 10 also includes an enclosure 32 that at least partially encloses filament delivery device 14 and stage 18, and optionally, energy source 25. In some examples, enclosure 32 substantially fully encloses delivery device 14 and stage 18, such that the environment within enclosure 32 may be controlled. In some examples, enclosure 32 includes or is coupled to a heat source configured to heat the interior environment of enclosure 32, a gas source and/or pump configured to control an atmospheric composition of the interior environment of enclosure 32, or the like. In this way, enclosure 32 may protect filament 20 and softened filament 24 during formation of the additively manufactured component, e.g., from unwanted chemical reactions that may change properties of the metal or alloy powder.

Filament reel 22 holds a filament 20 having a selected composition. In some examples, system 10 includes a single filament reel 22 holding a single filament 20 having a single composition. In other examples, system 10 may include multiple filament reels 22, each filament reel holding a filament 20 having a selected composition. Regardless of the number of filaments 20 and filament reels 22, in some examples, each filament may include a metal or alloy powder and a binder configured to bind the metal or alloy powder in filament 20. In some examples, the powder may include other types of powders in addition to, or as an alternative to, metal or alloy powder. In some examples, the powder may include ceramic powder.

The metal or alloy powder may include any suitable metal or alloy for forming an additively manufactured component. In some examples, the metal or alloy powder include a high-performance metal or alloy for forming component used in mechanical systems, such as a steel (e.g., stainless steel), a nickel-based alloy, a cobalt-based alloy, a titanium-based alloy, or the like. In some examples, the metal or alloy powder may include one or more refractory metals such as, e.g., Ti, V, Cr, Mn, Zr, Nb, Mo, Tc, Ru, Rh, Hf, Ta, W, Re, Os, and Ir. Refractory metals may have a high melting temperature making them undesirable, impractical or not useable in a powder bed fusion process. In some examples, the powder may include a refractory metal or a refractory metal alloy, such as molybdenum or a molybdenum alloy (such as a titanium-zirconium-molybdenum or a molybdenum-tungsten alloy), tungsten or a tungsten alloy (such as a tungsten-rhenium alloy or an alloy of tungsten and nickel and iron or nickel and copper), niobium or a niobium alloy (such as a niobium-hafnium-titanium alloy), tantalum or a tantalum alloy, rhenium or a rhenium alloy, or combinations thereof. In some examples, the metal or alloy powder may include a nickel-based, iron-based, or titanium-based alloy that includes one or more alloying additions such as one or more of Mn, Mg, Cr, Si, Co, W, Ta, Al, Ti, Hf, Re, Mo, Ni, Fe, B, Nb, V, C, and Y. In some examples, the metal or alloy powder may include a polycrystalline nickel-based superalloy or a polycrystalline cobalt-based superalloy, such as an alloy including NiCrAlY or CoNiCrAlY. For example, the metal or alloy may include an alloy that includes 9 to 10.0 wt. % W, 9 to 10.0 wt. % Co, 8 to 8.5 wt. % Cr, 5.4 to 5.7 wt. % Al, about 3.0 wt. % Ta, about 1.0 wt. % Ti, about 0.7 wt. % Mo, about 0.5 wt. % Fe, about 0.015 wt. % B, and balance Ni, available under the trade designation MAR-M-247, from MetalTek International, Waukesha, Wis. In some examples, the metal or alloy may include an alloy that includes 22.5 to 24.35 wt. % Cr, 9 to 11 wt. % Ni, 6.5 to 7.5 wt. % W, less than about 0.55 to 0.65 wt. % of C, 3 to 4 wt. % Ta, and balance Co, available under the trade designation MAR-M-509, from MetalTek International. In some examples, the metal or alloy may include an alloy that includes 19 to 21 wt. % Cr, 9 to 11 wt. % Ni, 14 to 16 wt. % W, about 3 wt. % Fe, 1 to 2 wt. % Mn, and balance Co, available under the trade designation L605, from Rolled Alloys, Inc., Temperance, Mich. In some examples, a metal or alloy may include a chemically modified version of MAR-M-247 that includes less than 0.3 wt. % C, between 0.05 and 4 wt. % Hf, less than 8 wt. % Re, less than 8 wt. % Ru, between 0.5 and 25 wt. % Co, between 0.0001 and 0.3 wt. % B, between 1 and 20 wt. % Al, between 0.5 and 30 wt. % Cr, less than 1 wt. % Mn, between 0.01 and 10 wt. % Mo, between 0.1 and 20. % Ta, and between 0.01 and 10 wt. % Ti. In some examples, the metal or alloy may include a nickel based alloy available under the trade designation IN-738 or Inconel 738, or a version of that alloy, IN-738 LC, available from All Metals & Forge Group, Fairfield, N.J., or a chemically modified version of IN-738 that includes less than 0.3 wt. % C, between 0.05 and 7 wt. % Nb, less than 8 wt. % Re, less than 8 wt. % Ru, between 0.5 and 25 wt. % Co, between 0.0001 and 0.3 wt. % B, between 1 and 20 wt. % Al, between 0.5 and 30 wt. % Cr, less than 1 wt. % Mn, between 0.01 and 10 wt. % Mo, between 0.1 and 20 wt. % Ta, between 0.01 and 10 wt. % Ti, and a balance Ni. In some examples, the metal or alloy may include may include an alloy that includes 5.5 to 6.5 wt. % Al, 13 to 15 wt. % Cr, less than 0.2 wt. % C, 2.5 to 5.5 wt. % Mo, Ti, Nb, Zr, Ta, B, and balance Ni, available under the trade designation IN-713 from MetalTek International, Waukesha, Wis.

In some examples, in addition to a metal or alloy powder, the powder may include a ceramic, such as an oxide. For example, the powder may include an oxide-dispersion strengthened (ODS) alloy. The ODS alloy may include at least one of a superalloy or a particle-dispersion strengthened alloy. ODS alloys are alloys strengthened through the inclusion of a fine dispersion of oxide particles. For example, an ODS alloy may include a high temperature metal matrix (e.g., any of the metals or alloys described above) that further include oxide nanoparticles, for example, yttria (Y₂O₃). Other example ODS alloys include nickel chromium ODS alloys, thoria-dispersion strengthened nickel and nickel chromium alloys, nickel aluminide and iron aluminide ODS alloys, iron chromium aluminide ODS alloys. Other strengthening particles may include alumina, hafnia, zirconia, beryllia, magnesia, titanium oxide, and carbides including silicon carbide, hafnium carbide, zirconium carbide, tungsten carbide, and titanium carbide.

Powders including ODS alloys may be formed by, for example, mixing a plurality of particles of metal(s) and oxide(s) forming the ODS alloy to form a mixture, optionally melting at least part of the mixture to form a melted mixture including oxide particles, and, if the mixture is melted, atomizing the melted mixture into the powdered form. Alternatively, the powdered form of the ODS alloy may be provided by hydrometallurgical processes, or any suitable technique for preparing an ODS alloy.

In some examples, ODS alloys may be characterized by the dispersion of fine oxide particles and by an elongated grain shape, which may enhance high temperature deformation behavior by inhibiting intergranular damage accumulation.

In some examples, the powder of filament 20 may include a ceramic, e.g., as an alternative to a metal or alloy powder. In some examples, the powder may include a ceramic, such as a nitride, carbide, or oxide, or carbon. Suitable ceramic materials include, for example, a silicon-containing ceramic, such as silica (SiO₂), silicon carbide (SiC), and/or silicon nitride (Si₃N₄); alumina (Al₂O₃); an aluminosilicate; a transition metal carbide (e.g., WC, Mo₂C, TiC); a silicide (e.g., MoSi₂, NbSi₂, TiSi₂); combinations thereof; or the like. In some examples, the ceramic functions as a reinforcement material in a final component formed from the filament. The powder thus may include continuous or discontinuous reinforcement material. For example, the reinforcement material may include discontinuous whiskers, platelets, fibers, or particulates. Additionally, or alternatively, the reinforcement material may include a continuous monofilament or multifilament two-dimensional or three-dimensional weave, braid, fabric, or the like, within filament 20. In some examples, the reinforcement material may include carbon (C), silicon carbide (SiC), silicon nitride (Si₃N₄), an aluminosilicate, silica (SiO₂), a transition metal carbide or silicide (e.g. WC, Mo₂C, TiC, MoSi₂, NbSi₂, TiSi₂), or the like.

In some examples, the powder of filament 20 may include a polymer powder such as those described herein, e.g., as an alternative to a metal or alloy powder.

Filament 20 also includes a sacrificial binder. The sacrificial binder may include a polymeric material, such as a thermoplastic. Example thermoplastics include polyvinyl alcohol, polyolefins, polystyrene, acrylonitrile butadiene styrene, polylactic acid, thermoplastic polyurethanes, aliphatic polyamides, or the like, or combinations thereof. The metal or alloy powder may be dispersed in the sacrificial binder, for example substantially uniformly dispersed in the sacrificial binder.

In some examples, the sacrificial binder may be in the form of a curable polymer precursor. The curable polymer precursor may be curable (for example, thermally curable or photocurable) to form the sacrificial binder. For example, the curable polymer precursor may be cured as softened filaments 24 are extruded and/or after softened filaments 24 are laid down in roads 26 to form a material including the metal or alloy powder dispersed in the sacrificial binder, for example substantially uniformly dispersed in the sacrificial binder. The curable polymer precursor may include a precursor, for example, one or more monomers, oligomers, or non-crosslinked polymers suitable for forming the polymeric material of the sacrificial binder upon curing. Thus, in some examples, energy source 25 may direct energy at a curable polymer precursor, for example, in the material, to selectively cure the curable polymer precursor to form roads 26 including the material that includes the metal or alloy powder and the sacrificial binder. In other examples, the heat to which the composition is exposed to form softened filaments 24 may initiate the curing reaction, and no additional energy source is used.

In some examples, filament 20 includes a selected amount of sacrificial binder and metal or alloy powder so that the material in roads 26 may include more than about 80% by volume of the powder, which may result in a substantially rigid component with reduced porosity being formed in response to removal of the sacrificial binder. In some examples, filament 20 includes sacrificial binder in an amount configured to cause the material to shrink by less than about 20 volume percent relative to an initial volume of the material in response to removing the sacrificial binder. For example, filament 20 may include less than about 20% by volume of the sacrificial binder. In some examples, a relatively low amount of binder may be used to form a portion of an example ballistic armor article that has a relatively high density.

In some examples, filament 20 includes at least one shrink-resistant agent. For example, the at least one shrink-resistant agent may include a ceramic, instead of, or in addition to, the oxide in any ODS present in the material(s).

In some examples, the ratio of binder to powder in filament 20 may be tailored to provide for a relatively low-density portion of the ballistic armor article after the binder has been sacrificed and the powder sintered. A low density portion of the ballistic armor article may define a preferential failure portion of the armor article (e.g., that fractures and/or fragments in response to a projective impacting the ballistic armor article) to absorb the kinetic energy and disperse the energy over the low density portion of the armor article. In some examples, filament 20 includes less than about 80% by volume of the powder.

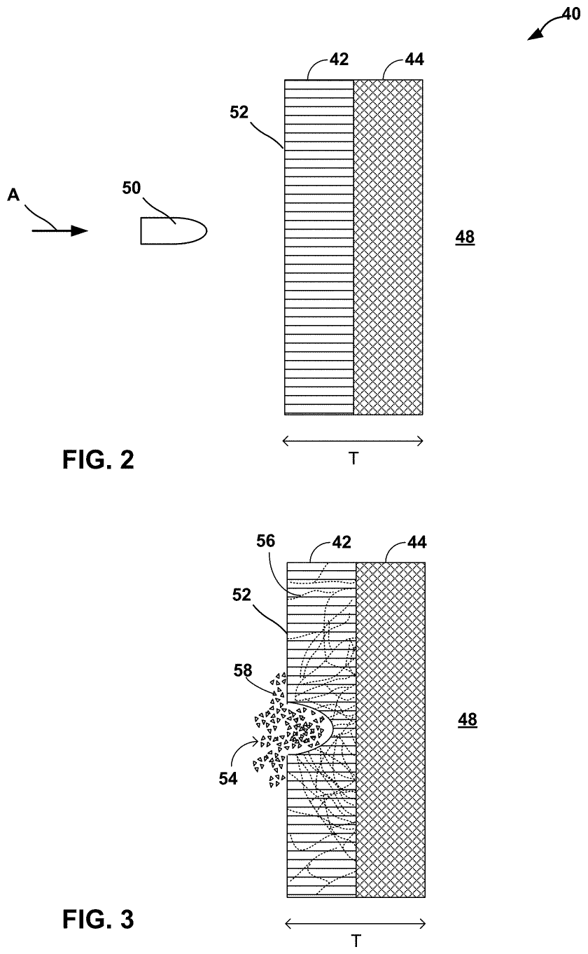

FIG. 2 is a schematic diagram illustrating a cross-section of an example ballistic armor article 40 according to an example of the disclosure. Article 40 includes first portion 42 and second portion 44, and has an overall thickness T. As described herein, article 40 may be formed by a FFF process. For example, each of first portion 42 and second portion 44 may be formed by depositing a filament, such as filament 24, including a powder in a binder, where the binder is subsequently sacrificed and the powder sintered to form first portion 42 and second portion 44. In other examples, some but not all of first portion 42 and second portion 44 may be formed by deposition of a filament including a powder and binder. For example, a filament may be deposition on second portion 44, which acts as a substrate to deposit the filament onto, to form first portion 42. However, second portion 44 may be formed by a process other than that of a FFF process.

Ballistic armor article 40 is configured to protect an underlying environment 48 from damage caused by projectile 50 moving along a direction shown by the arrow A. For example, ballistic armor article 40 may be configured to prevent projectile 50 from penetrating through article 40 to environment 48, e.g., by absorbing the kinetic energy of projectile 50 without projectile 50 penetrating all the way through article 40. In some examples, all or a portion of projectile 50 may penetrate barrier 40 but at a velocity and/or mass that does not damage environment 48. In some examples, projectile 50 may impact article 40 in what may be characterized as a ballistic impact with a projectile 50 having a high relative velocity and relatively low mass.

In FIG. 2, underlying environment 48 may be representative of a portion of a human body, an interior or underlying component of a vehicle or other system. As described above, ballistic armor 40 may be employed to protect a portion of a human body or vehicles, such as, aircraft, a wheeled vehicle, tracked vehicle, or the like from projectile 50. In some examples, ballistic armor article 40 protects all or a portion of engine of a vehicle, such as an aircraft, from damage caused by a projectile impact by forming a barrier between projectile 50 and engine. Ballistic armor article 50 may protect such objects from impacts with projectile 50 moving at relatively high velocity. Projectile 50 may be a bullets or other particle defining a mass with a relatively high velocity. In some examples, ballistic armor article may also protect underlying environment 48 from shrapnel (e.g., from an explosion and/or fragments of projectile 50 after impact with article 40). In some examples, article 40 may be employed to protect systems and components in space and/or those that operate in low or microgravity environments. Those systems and components may include artificial satellites, including telescopes or other man-made systems that operate in orbit of a planet. Article 40 may be employed to protect such objects from impacts from projectile 50, including ballistic and non-ballistic impacts from, e.g., relatively small objects as compared to the size of the ballistic article 40.

As shown in FIG. 2, first portion 42 defines outer surface 52 of article 40, and second portion 44 is located between first portion 42 and environment 44. To provide a barrier that protects underlying environment 48 from projectile 50, e.g., by preventing penetration of projectile 50 through article 40, first portion 42 and second portion 44 may have different properties. In some examples, first portion 42 and second portion 44 have different compositions. Additionally, or alternatively, first portion 42 and second portion 44 have different densities. Additionally, or alternatively, first portion 42 and second portion 44 have different harnesses. Additionally, or alternatively, first portion 42 and second portion 44 have a different fracture toughness. Additionally, or alternatively, first portion 42 and second portion 44 have a different elastic modulus. Additionally, or alternatively, first portion 42 and second portion 44 have a different yield strength. Additionally, or alternatively, first portion 42 and second portion 44 have different geometries. The differing properties of first portion 42 and second portion 44 may allow for one of first portion 42 and second portion 44 to preferentially fail, e.g., fracture and fragment, before the other of first portion 42 and second portion 44. In some examples, the preferential failure of first portion 42 or second portion 44 may absorb kinetic energy from the impact of projectile 50. The absorbed kinetic energy in combination with the other of first portion 42 or second portion 44 that does not preferentially fail may protect the underlying environment 48 from projectile 50.

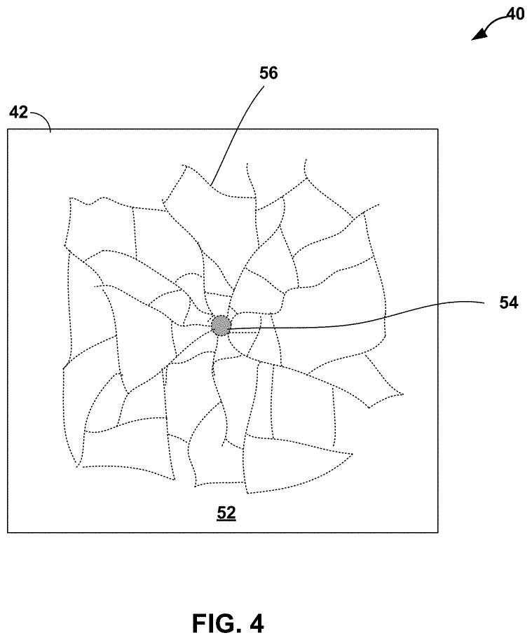

In one example, the densities of first portion 42 and second portion 44 differ from one another. For example, first portion 42 may have a lower density than second portion 44. In some examples, first portion 42 may be configured to fracture and fragment upon impact by projectile 50 with surface 52. This may be a function of the density of first portion 42 and/or other properties of first portion 42. FIGS. 3 and 4 are schematic diagrams illustrating cross-sectional and plan views, respectively, of article 40 after impact of projectile 50 with surface 52 of article 40 at impact zone 54. As shown, first portion 42 fractures along dashed lines 56, which fragment the material. Due at least in part to the properties of first portion 42 (e.g., the density), the fracture 56 of first portion 42 may be spread over a relatively large volume of first portion 42 rather than only the volume directly adjacent to impact zone 54. In this manner, the kinetic energy absorbed by first portion 42 may be greater than the amount absorbed if a smaller volume of first portion 42 where to fracture and fragment from the impact of projectile 50.

In some examples, while first portion 42 fractures and fragments as a result of the impact with projectile 50, second portion 44 may remain intact, e.g., without fracturing or fragmenting, due to the kinetic energy absorbed by first portion 42 and/or higher density of second portion 44. This may be a function of the density and/or other properties of second portion 44, e.g., relative to first portion 42. In this manner, first portion 42 may define a preferential failure zone of article 40, e.g., since first portion 42 is configured to fracture and fragment preferentially compared to second portion 44.

In some examples, second portion 44 may function as a barrier that remains intact to prevent penetration of projectile 50 and/or fragments 58 of projectile 50 and/or first portion 42. While FIG. 3 illustrates impact zone 56 of projectile 50 only partially penetrating portion 42, in some examples, impact zone 56 of projectile 50 may also penetrate into second portion 44. In some examples, at least a part of second portion 44 may also fracture or otherwise fail to some extent but may still prevent penetration of projectile 50 or fragments 58 into environment 48 or at least prevent damage to environment 48 by any portion of projectile 50 that penetrates into environment 48.

In some examples, the density of first portion 42 may be less than second portion 44. In some examples, first portion 42 may have a lower density than second portion 44 based on the material selected for each of the portions, with first portion 42 being formed of a material with less density than the material of second portion 44. In such an example, article 40 may be considered a multiple layer article with each of the first portion and second portion 42 and 44 being an individual layer. In other examples, article 40 may be a single layer article with first portion 42 may be formed of the same material as second portion 44 but with first portion 42 having a higher porosity than the porosity of second portion 44. In some examples, the porosity of first and second portions 42 and 44 may be controlled based on the amount of binder in filament 24 used to form the respective portions 42 and 44, e.g., with a higher volume percentage of binder resulting in a higher porosity and lower density of the resulting sintered material.

While the example article 40 is shown as having a distinct boundary between first portion 42 and second portion 44 to define volumes of different properties, in other examples, the difference between the properties of first portion 42 and second portion 44 may be more gradual. For example, there may be a substantially continuous gradient for the density of article 40, where the lowest density of article 40 is at or near impact surface 52, the highest density is at or near the opposite surface, and there is a gradual increase moving from the area of low density to high density in the intermediate portion of article 40. The use of a FFF process may readily produce an article with such a property gradient, e.g., along thickness T of article 40.

In the example of FIGS. 2-4, article 40 may include first portion 42 that is tailored to preferentially fail, e.g., by fracturing and fragmenting upon impact by projectile 50, relative to second portion 44. The preferential failure of first portion 42 may be defined based on the differing densities, as described above. In some examples, the preferential failure of a ballistic armor article such as article 40 may be additionally, or alternatively, achieved based on other properties of first portion 42 and second portion 44 that differ between the portions. Such additional properties may include material composition, hardness, fracture toughness, elastic modulus, yield strength, and/or geometry (e.g., cross-sectional thickness and/or profile).

For example, first portion 42 may have a different material composition than second portion 44. As another example, first portion 42 and second portion 44 may have different hardness. As another example, first portion 42 and second portion 44 may have different fracture toughness. As another example, first portion 42 and second portion 44 may have different elastic modulus. As another example, first portion 42 and second portion 44 may have different yield strength. As another example, first portion 42 and second portion 44 may have different thickness (e.g., in the overall thickness direction T of article 40).

While the example article 40 of FIGS. 2-4 is illustrated as having two portions 42 and 44 with different densities and/or other differing properties, other examples are contemplated. For example, article 40 may include three portions each having different properties (e.g., three portions of different compositions). In the example of article 40 may include an intermediate portion between first portion 42 and second portion 44. In such an example, first portion 42 may be configured to fail (e.g., fracture and fragment) upon impact from projectile 50 at a certain level of impact force. If the projectile 50 penetrates first portion 42, the projectile 50 encounters the intermediate portion, which may absorb even more kinetic energy. If the projectile 50 breaches the intermediate portion, the projectile 50 encounters second portion 44, which may be configured to absorb even more kinetic energy from the projectile 50 and further protect the integrity of underlying environment 48, e.g., by preventing penetration of projectile 50 into environment 48.

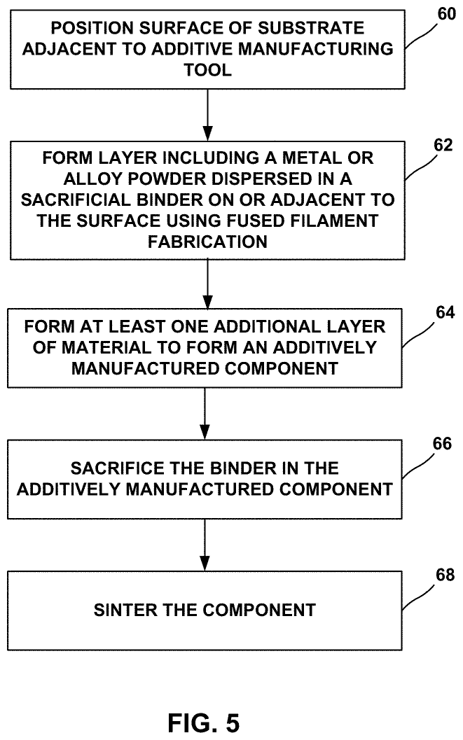

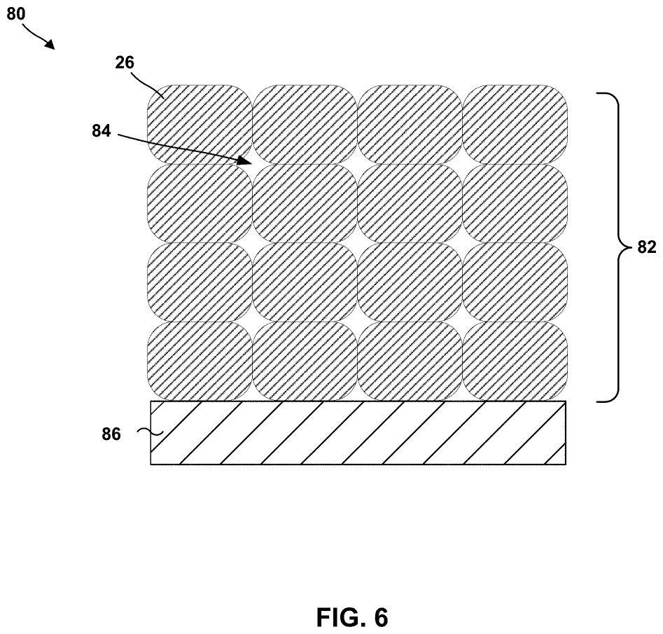

An example technique that may be implemented by system 10 will be described with concurrent reference to FIG. 5. FIG. 5 is a flow diagram illustrating an example technique for forming an additively manufactured component including at least one feature smaller than a base resolution of the additive manufacturing technique. In some examples, the example technique of FIG. 5 may be used to form a ballistic armor article, such as article 40 described herein. Although the technique of FIG. 5 is described with respect to system 10 of FIG. 1, in other examples, the technique of FIG. 5 may be performed by other systems, such a system 30 including fewer or more components than those illustrated in FIG. 1. Similarly, system 10 may be used to performed other additive manufacturing techniques.

The technique of FIG. 5 includes positioning substrate 30 including surface 28 adjacent to a build position, e.g., on stage 18 (60). In some examples, system 10 may not include a separate substrate 30, the technique of FIG. 5 may include positioning a build surface defined by stage 18, or by another component, or layers of prior softened filament 24 or another material.

The technique of FIG. 5 also includes forming a road 26 of material using fused filament fabrication (62). Computing device 12 may cause filament delivery device 14 to deposit softened filament 24 in one or more roads 26 to ultimately form the additively manufactured component. A plurality of roads 26 defining a common plane may define a layer of material. Thus, successive roads 26 may define a series of layers, for example, parallel layers, and the series of layers may eventually define the additively manufactured component.

The technique of FIG. 5 also includes forming, on roads 26 of material, at least one additional layer of material to form an additively manufactured component (64). For example, computing device 12 may control movement and positioning of filament delivery device 14 relative to stage 18, and vice versa, to control the locations at which roads are formed. Computing device 12 may control movement of filament delivery device 14, stage 18, or both, based on a computer aided manufacturing or computer aided design (CAM/CAD) file. For example, computing device 12 may control filament delivery device 14 to trace a pattern or shape to form a layer including a plurality of roads 26 on surface 28. Computing device 12 may control filament delivery device 14 or stage 18 to move substrate 30 away from filament delivery device 14, then control filament delivery device 14 to trace a second pattern or shape to form a second layer including a plurality of roads on the previously deposited layer. Computing device 12 may control stage 18 and filament delivery device 14 in this manner to result in the plurality of layers, each layer including a traced shape or design. Together, the plurality of layers defines an additively manufactured component (64).

The technique of FIG. 55 includes, after forming the additively manufacturing component (64), sacrificing the binder from the component (66). The sacrificing (66) may include delivering thermal or any suitable energy, for example, by energy source 25, to roads 24 in an amount sufficient to cause binder to be substantially oxidized, incinerated, carbonized, charred, decomposed, or removed from roads 24, while leaving the metal or alloy powder substantially intact. In other examples, the additively manufactured component may be placed in a furnace to heat the additively manufactured component and cause removal of the binder from the component (66).

The technique of FIG. 5 also includes, after sacrificing the binder (66), sintering the component (68). The sintering may include a thermal treatment, for example, one or more predetermined cycles of exposure to predetermined temperatures for predetermined times. In some examples, energy source 25 may deliver energy to cause sintering. In other examples, the additively manufactured component may be placed in a furnace to heat the additively manufactured component and cause sintering. In some examples, the sintering (CC) may promote the bonding of particles of powder to each other to strengthen the component including substantially only the powder after the binder is sacrificed. Sintering may not melt the particles of powder, thus leaving the microstructure of the particles substantially intact. This may facilitate forming components with selected microstructures compared to techniques that include melting the powder. The sintering (68) may also densify an interior or a surface region of the component, for example, by promoting powder compaction and reducing porosity. In some examples, the steps of removing the sacrificial binder (BB) and sintering the component (68) may be combined in a single heating step or series of heating steps, e.g., within a furnace.

FIG. 6 is a schematic diagram illustrating a cross-sectional view an example article 80 including a composite coating 82 on substrate 86. Composite coating 82 may correspond to ballistic armor article 40 describe previously made by a FFF process such as that described in FIG. 5 but prior to the sacrificing of the binder from filament 24 and sintering the powder of filament 24. Put another way, ballistic armor article 40 may be formed from composite coating 82 once composite coating 82 is processed to sacrifice the binder from coating 82 and sinter the powder from coating 82. In some examples, substrate 86 may be a sacrificial substrate that is not incorporated into ballistic armor article 40 but instead provide a build surface for making article 40. Alternatively, substrate 84 may be a portion of article 40 (e.g., first portion 42 or second portion 44), or even another layer that is in contact with first portion 42 or second portion 44, where that portion of article 40 is not made by an FFF process.

In some examples, substrate 84 may define a surface of a component that ballistic article 40 provides protection. For example, in the case of a vehicle that is protected by article 40, substrate 84 may correspond to an outer surface of the vehicle. In this manner, article 40 may be formed directly on a component that is to be protected by article 40, e.g., rather than having to prefabricate article 40 and subsequently attach or otherwise fix the article to the component.

As shown in FIG. 6, composite coating 82 is formed by depositing filament 24 to forms roads 26 that may be arranged adjacent to each other, e.g., in a four by four array of columns and rows like that shown. While a four by four array is shown for ease of illustration, it is contemplated that more or less rows and columns may be used to form article 40. Channels 84 in coating 82 may be present in areas where the filament material of roads 26 are not in contact with each other. In some examples, channels 84 may be removed after sintering of the powders in road 82.

Alternatively, composite coating 82 may be configured such that a void space remains in the areas of channels 84 after sintering in some areas of coating 82. In this manner, the density of ballistic article 40 at first portion 42 may be decreased compared to examples in which channels 84 do not remain after composite coating is sintered. As noted above, first portion 42 may have a low density that second portion 44, e.g., so that first portion 42 define a preferential failure portion of article 40. The design of channels 84 to result in void spaces in the volume of composite coating 82 that correspond to first portion 42 of article 40 after sintering may allow for another way to decrease the overall density first portion 42. The density of first and second portions 42 and 44 may additionally or alternatively be derived from sacrificing the binder in each road 26 to leave powder. As the volume percentage of binder within road 26 increases, the porosity of the remaining powder in road 26 may increase, thus decreasing the density of article 40 in one or more areas once the powder of road 26 is sintered.

As noted above, one or more properties of article 40 may be nonuniform within article 40, e.g., with first portion 42 and second portion 44 having different properties to define a preferential failure site within article 40 and/or other result that help article 40 protect against impact from projectile 50. To define a gradient for a property, such as material composition, density, hardness, fracture toughness, elastic modulus, and/or yield strength, of article 40, the composition or other properties of the individual roads 26 in composite coating 82 may be varied. For example, during the FFF process of FIG. 5, the composition of the powder and/or amount of binder in filament 24 may vary such that the composition and/or amount of binder for the individual roads 26 show in FIG. 6 varies. The variance may be used to tailor the properties of article 40 as described herein. For example, the bottom two rows of roads 26 may have a different powder composition and/or different amount of binder compared to the top two rows of roads 26 in composite coating 82 so that the properties of article 40 are different near the impact surface 52 of article 40 compared to nearer the underlying environment 48 to be protected by article 40 after sacrificing the binder and sintering the powder of composite coating 82. In this way, using a FFF process to form article 40 may be beneficial, e.g., as compared to other technique for forming a thermal coating. Additionally, or alternatively, the use of a FFF process may allow for the use of dissimilar materials to form article 40, e.g., those materials that may be readily melted or fused to each other. Additionally, or alternatively, the use of a FFF process may allow for the manufacture of article 40 in space or other low gravity or zero gravity environment, since the FFF process may be configured to deposit filament 24 in such an environment.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following clause and claims.

Clause 1. A method for forming a ballistic armor article, the method comprising: forming a preform article by depositing a filament via a filament delivery device, wherein the filament includes a sacrificial binder and a powder; removing substantially all the binder from the preform article to form a powder article; and sintering the powder article to form the ballistic armor article, wherein the ballistic armor article is configured to absorb energy from an external projectile that impacts the ballistic armor article with a kinetic energy below a threshold amount, and wherein the ballistic armor article is configured to prevent the projectile with the kinetic energy below the threshold amount from penetrating through the ballistic armor article.

Clause 2. The method of clause 1, wherein the powder comprises at least one of metal, alloy, or ceramic.

Clause 3. The method of any one of clauses 1 or 2, wherein the ballistic armor article includes a plurality of portions, wherein each portion the plurality of portions has at least one different property from at least one other portion of the plurality of portions.

Clause 4. The method of clause 3, wherein the different property includes at least one of geometry, material composition, density, hardness, fracture toughness, elastic modulus, or yield strength.

Clause 5. The method of any one of clauses 3 or 4, wherein the different property defines a preferential failure portion of the ballistic armor article that fractures in response to impact to the ballistic armor article by the projectile to absorb the kinetic energy.

Clause 6. The method of any one of clauses 1-5, wherein the ballistic armor article includes a first portion having a first composition and the second portion having a second composition different from the first composition.

Clause 7. The method of any one of clauses 1-6, wherein the ballistic armor article includes a first portion having a first density and the second portion having a second density different from the first density.

Clause 8. The method of any one of clauses 1-7, wherein the ballistic armor article includes a first portion having a first hardness and the second portion having a second hardness different from the first density.

Clause 9. The method of any one of clauses 1-8, wherein the first portion defines an impact surface and a second portion is adjacent the first portion and opposite the impact surface.

Clause 10. The method of any one of clauses 1-9, further comprising incorporating the ballistic armor article into a system to protect the system from impact from the external projectile.

Clause 11. The method of clause 10, wherein the system comprises a vehicle.

Clause 12. The method of clause 11, wherein the vehicle comprises an aircraft.

Clause 13. The method of clause 12, wherein the ballistic armor is incorporated into the aircraft to protect an engine of the aircraft from impact with the external projectile.

Clause 14. The method of clause 10, wherein the system is configured to operate in outer space, and wherein the ballistic armor article is configured to protect the system from impact with the external projectile in outer space.

Clause 15. The method of clause 10, wherein the system comprises a human body, and wherein the ballistic armor article is incorporated as body armor to protect a portion of the human body from impact with the external projectile.

Clause 16. An additively manufactured ballistic armor article formed from a filament including a powder and a binder, wherein the ballistic armor article is configured to absorb energy from an external projectile that impacts the ballistic armor article with a kinetic energy below a threshold amount, and wherein the ballistic armor article is configured to prevent the projectile with the kinetic energy below the threshold amount from penetrating through the ballistic armor article.

Clause 17. The article of clause 16, wherein the powder comprises at least one of metal, alloy, or ceramic.

Clause 18. The article of any one of clauses 16 or 17, wherein the ballistic armor article includes a plurality of portions, wherein each portion the plurality of portions has at least one different property from at least one other portion of the plurality of portions.

Clause 19. The article of clause 18, wherein the different property includes at least one of geometry, material composition, density, hardness, fracture toughness, elastic modulus, or yield strength.

Clause 20. The article of any one of clauses 18 or 19, wherein the different property defines a preferential failure portion of the ballistic armor article that fractures in response to impact to the ballistic armor article by the projectile to absorb the kinetic energy.

Clause 21. The article of any one of clauses 16-21, wherein the ballistic armor article includes a first portion having a first composition and the second portion having a second composition different from the first composition.

Clause 22. The article of any one of clauses 16-21, wherein the ballistic armor article includes a first portion having a first density and the second portion having a second density different from the first density.

Clause 23. The article of any one of clauses 16-22, wherein the ballistic armor article includes a first portion having a first hardness and the second portion having a second hardness different from the first density.

Clause 24. The article of any one of clauses 16-23, wherein the first portion defines an impact surface and a second portion is adjacent the first portion and opposite the impact surface.

Clause 25. The article of any one of clauses 16-24, further comprising incorporating the ballistic armor article into a system to protect the system from impact from the external projectile.

Clause 26. The article of clause 25, wherein the system comprises a vehicle

Clause 27. The article of clause 26, wherein the vehicle comprises an aircraft.

Clause 28. The article of clause 27, wherein the ballistic armor is incorporated into the aircraft to protect an engine of the aircraft from impact with the external projectile.

Clause 29. The article of clause 25, wherein the system is configured to operate in outer space, and wherein the ballistic armor article is configured to protect the system from impact with the external projectile in outer space.

Clause 30. The article of clause 25, wherein the system comprises a human body, and wherein the ballistic armor article is incorporated as body armor to protect a portion of the human body from impact with the external projectile.

Clause 31. An additive manufacturing system comprising a substrate defining a major surface; a filament delivery device; and a computing device configured to control the filament delivery device to form a preform article, wherein the filament includes a sacrificial binder and a powder; wherein substantially all the binder is configured to be removed from the preform article, and the article sintered to form a ballistic armor article, wherein the ballistic armor article is configured to absorb energy from an external projectile that impacts the ballistic armor article with a kinetic energy below a threshold amount, and wherein the ballistic armor article is configured to prevent the projectile with the kinetic energy below the threshold amount from penetrating through the ballistic armor article.

Clause 32. An additive manufacturing system comprising a substrate defining a major surface; a filament delivery device; and a computing device configured to perform one or more of the methods described in the disclosure or a method according to any one of clauses 1-15.

What is claimed is:

1. A method for forming a ballistic armor article, the method comprising:
forming a preform article by depositing a filament via a filament delivery device, wherein the filament includes a sacrificial binder and a powder;
removing substantially all the binder from the preform article to form a powder article; and
sintering the powder article to form the ballistic armor article, wherein the ballistic armor article is configured to absorb energy from an external projectile that impacts the ballistic armor article with a kinetic energy below a threshold amount, and wherein the ballistic armor article is configured to prevent the projectile with the kinetic energy below the threshold amount from penetrating through the ballistic armor article.

2. The method of claim 1, wherein the powder comprises at least one of metal, alloy, or ceramic.

3. The method of claim 1, wherein the ballistic armor article includes a plurality of portions, wherein each portion the plurality of portions has at least one different property from at least one other portion of the plurality of portions.

4. The method of claim 3, wherein the different property includes at least one of geometry, material composition, density, hardness, fracture toughness, elastic modulus, or yield strength.

5. The method of claim 3, wherein the different property defines a preferential failure portion of the ballistic armor article that fractures in response to impact to the ballistic armor article by the projectile to absorb the kinetic energy.

6. The method of claim 1, wherein the ballistic armor article includes a first portion having a first composition and the second portion having a second composition different from the first composition.

7. The method of claim 1, wherein the ballistic armor article includes a first portion having a first density and the second portion having a second density different from the first density.

8. The method of claim 1, wherein the ballistic armor article includes a first portion having a first hardness and the second portion having a second hardness different from the first density.

9. The method of claim 1, wherein the first portion defines an impact surface and a second portion is adjacent the first portion and opposite the impact surface.

10. The method of claim 1, further comprising incorporating the ballistic armor article into a system to protect the system from impact from the external projectile.

11. The method of claim 10, wherein the system comprises a vehicle,

12. The method of claim 11, wherein the vehicle comprises an aircraft.

13. The method of claim 12, wherein the ballistic armor is incorporated into the aircraft to protect an engine of the aircraft from impact with the external projectile.

14. The method of claim 10, wherein the system is configured to operate in outer space, and wherein the ballistic armor article is configured to protect the system from impact with the external projectile in outer space.

15. The method of claim 10, wherein the system comprises a human body, and wherein the ballistic armor article is incorporated as body armor to protect a portion of the human body from impact with the external projectile.

16. An additively manufactured ballistic armor article formed from a filament including a powder and a binder, wherein the ballistic armor article is configured to absorb energy from an external projectile that impacts the ballistic armor article with a kinetic energy below a threshold amount, and wherein the ballistic armor article is configured to prevent the projectile with the kinetic energy below the threshold amount from penetrating through the ballistic armor article.

17. The article of claim 16, wherein the powder comprises at least one of metal, alloy, or ceramic.

18. The article of claim 16, wherein the ballistic armor article includes a plurality of portions, wherein each portion the plurality of portions has at least one different property from at least one other portion of the plurality of portions.

19. The article of claim 18, wherein the different property includes at least one of geometry, material composition, density, hardness, fracture toughness, elastic modulus, or yield strength.

20. An additive manufacturing system comprising:
a substrate defining a major surface;
a filament delivery device; and
a computing device configured to:
control the filament delivery device to form a preform article, wherein the filament includes a sacrificial binder and a powder;
wherein substantially all the binder is configured to be removed from the preform article, and the article sintered to form a ballistic armor article, wherein the ballistic armor article is configured to absorb energy from an external projectile that impacts the ballistic armor article with a kinetic energy below a threshold amount, and wherein the ballistic armor article is configured to prevent the projectile with the kinetic energy below the threshold amount from penetrating through the ballistic armor article.
